(19) United States
(12) Patent Application Publication
(10) Pub. No.: US 2010/0312536 A1
(43) Pub. Date: Dec. 9, 2010

(54) INTEGRATING FIELD DATA

(75) Inventors: Randy J. Vaal, Meadows Place, TX (US); Daniel Lucas-Clements, Oxfordshire (GB)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation

(21) Appl. No.: 12/864,808

(22) PCT Filed: Jan. 20, 2009
(86) PCT No.: PCT/US09/31442

§ 371 Date: Jul. 27, 2010

Related U.S. Application Data
(60) Provisional application No. 61/026,394, filed on Feb. 5, 2008.

(51) Int. Cl. G06G 7/48

(52) U.S. Cl. 703/10

(57) ABSTRACT

An example method of integrating field data that includes obtaining the field data associated with a field and performing a production analysis on the field data to generate a production output, the production analysis performed by a production engineering tool. The method further includes transforming the field data to obtain transformed field data requested by a field application and sending the transformed field data from the production engineering tool to the field application, the field application performing a field analysis using the transformed field data to generate a field output. The method further includes generating a comparison of the production output and the field output.

### CROSS-REFERENCE TO RELATED APPLICATIONS

This application claims priority pursuant to U.S. Provisional Patent Application No. 61/026,394 (Attorney Docket No. 09469/136001; 94.0188) entitled “System and Method For Performing Oilfield Production Operations,” filed Feb. 5, 2008 in the names of Randy J. Vaal and Daniel Lucas-Clements, the disclosure of which is incorporated by reference herein in its entirety.

### BACKGROUND

Geographic formations are often analyzed to determine the presence of subterranean assets, such as valuable fluids or minerals. Fields are developed within these geographic formations using field operations, such as surveying, drilling, wireline testing, completions, production, planning, and analysis. Information (e.g., data) obtained from both field operations and geographic formations is used to assess the underground formations, and this information is used to drive field operations to locate and, if applicable, extract the desired subterranean assets. Such data may be static or dynamic. Data may be obtained and used for current or future operations. When used for future operations at the same or other locations, such data may be referred to as historical data.

Data from one or more wellbores may be analyzed to plan or predict various outcomes at a given wellbore. There are usually a large number of variables and large quantities of data to consider in analyzing field operations. It is, therefore, often useful to model the behavior of the field operation to determine a desired course of action. Techniques have been developed to model the behavior of various aspects of field operations, such as geological structures, downhole reservoirs, wellbores, surface facilities as well as other portions of the field operation. Typically, there are different types of simulators for different purposes. For example, there are simulators that focus on reservoir properties, wellbore production, or surface processing.

Typically, simulators are designed to model specific behavior of discrete portions of the wellbore operation. Due to the complexity of field operations, most simulators are capable of evaluating a specific segment of the overall production system, such as simulation of the reservoir. Simulations of portions of the wellsite operation, such as reservoir simulation, flow through the wellbore or surface processing, are usually considered and used individually. A change in any segment of the production system, however, often has cascading effects on the upstream and downstream segments of the production system. For example, restrictions in the surface network may reduce productivity of the reservoir.

### SUMMARY

An example method of integrating field data that includes obtaining the field data associated with a field and performing a production analysis on the field data to generate a production output, the production analysis performed by a production engineering tool. The method further includes transforming the field data to obtain transformed field data requested by a field application and sending the transformed field data from the production engineering tool to the field application, the field application performing a field analysis using the transformed field data to generate a field output. The method further includes generating a comparison of the production output and the field output.

Other aspects of integrating field data will be apparent from the following description and the appended claims.

### BRIEF DESCRIPTION OF DRAWINGS

So that the above recited features can be understood in detail, a more particular description, briefly summarized above, may be had by reference to the embodiments thereof that are illustrated in the appended drawings. It is to be noted, however, that the appended drawings illustrate only some embodiments and are therefore not to be considered limiting of its scope, for this disclosure may admit to other equally effective embodiments.

FIGS. 1.1 to 1.4 illustrate simplified, schematic views of a field having subterranean formations containing reservoirs therein, the various field operations being performed in which one or more embodiments of integrating field data may be implemented.

FIG. 2 illustrates a schematic view of a field having a plurality of wellsites in which one or more embodiments of integrating field data may be implemented.

FIG. 3 illustrates a system in which one or more embodiments of integrating field data may be implemented.

FIG. 4 illustrates a production engineering tool of the system shown in FIG. 3 in which one or more embodiments of integrating field data may be implemented.

FIGS. 5 and 6 illustrate methods for integrating field data in accordance with one or more embodiments.

FIGS. 7.1 to 7.2 illustrate various examples being performed by a system in which one or more embodiments of integrating field data may be implemented.

FIG. 8 illustrates a computer system in which one or more embodiments of integrating field data may be implemented.

### DETAILED DESCRIPTION

One or more embodiments are shown in the above-identified figures and described in detail below. In describing the embodiments, like or identical reference numerals are used to identify common or similar elements. The figures are not necessarily to scale and certain features and certain views of the figures may be shown exaggerated in scale or in schematic in the interest of clarity and conciseness.

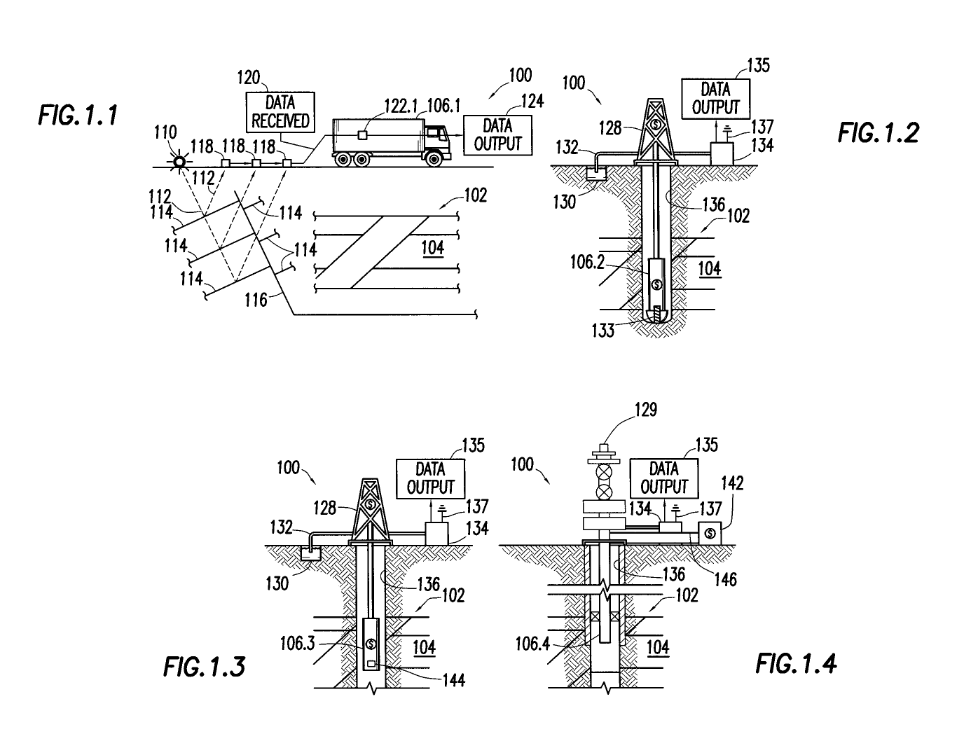

FIGS. 1.1 through 1.4 shows a field (100) having geological structures and/or subterranean formations therein. As shown in these figures, various measurements of the subterranean formation are taken by different tools at the same location. These measurements may be used to generate information about the formation and/or the geological structures and/or fluids contained therein.

FIGS. 1.1 through 1.4 depict schematic views of a field (100) having subterranean formations (102) containing a reservoir (104) therein and depicting various field operations being performed on the field (100). FIG. 1.1 depicts a survey operation being performed by a seismic truck (106.1) to measure properties of the subterranean formation. The survey operation is a seismic survey operation for producing sound vibration(s) (112). In FIG. 1.1, one such sound vibration (112) is generated by a source (110) and reflects off a plurality of horizons (114) in an earth formation (116). The sound vibration(s) (112) is (are) received in by sensors (S), such as geophone-receivers (118), situated on the earth's surface, and the geophone-receivers (118) produce electrical output signals, referred to as data received (120) in FIG. 1.

In response to the received sound vibration(s) (112) representative of different parameters (such as amplitude and/or frequency) of the sound vibration(s) (112). The data received (120) is provided as input data to a computer (122.1) of the seismic recording truck (106.1), and responsive to the input data, the recording truck computer (122.1) generates a seismic data output record (124). The seismic data may be further processed as desired, for example by data reduction.

FIG. 1.2 depicts a drilling operation being performed by a drilling tool (106.2) suspended by a rig (128) and advanced into the subterranean formation (102) to form a wellbore (136). A mud pit (130) is used to draw drilling mud into the drilling tool (106.2) via flow line (132) for circulating drilling mud through the drilling tool (106.2) and back to the surface. The drilling tool (106.2) is advanced into the formation to reach reservoir (104). The drilling tool (106.2) is adapted for measuring downhole properties. The drilling tool (106.2) may also be adapted for taking a core sample (133), as shown, or removed so that a core sample (133) may be taken using another tool.

A surface unit (134) is used to communicate with the drilling tool (106.2) and offsite operations. The surface unit (134) is capable of communicating with the drilling tool (106.2) to send commands to drive the drilling tool (106.2), and to receive data therefrom. The surface unit (134) is provided with computer facilities for receiving, storing, processing, and analyzing data from the field (100). The surface unit (134) obtains data output (135) generated during the drilling operation. Computer facilities, such as those of the surface unit (134), may be positioned at various locations about the field (100) and/or at remote locations.

Sensors (S), such as gauges, may be positioned throughout the reservoir, rig, field equipment (such as the downhole tool), or other portions of the field (100) for gathering information about various parameters, such as surface parameters, downhole parameters, and/or operating conditions. These sensors (S) measure field parameters, such as weight on bit, torque on bit, pressures, temperatures, flow rates, compositions and other parameters of the field operation.

The information gathered by the sensors (S) may be obtained by the surface unit (134) and/or other data sources for analysis or other processing. The data obtained by the sensors (S) may be used alone or in combination with other data. The data may be obtained in a database and all or portions of the data may be used for analyzing and/or predicting field operations of the current and/or other wellbores.

Data outputs from the various sensors (S) positioned about the field (100) may be processed for use. The data may be historical data, real time data, or combinations thereof. The real time data may be used in real time, or stored for later use. The data may also be combined with historical data or other inputs for further analysis. The data may be housed in separate databases, or combined into a single database.

The obtained data may be used to perform analysis, such as modeling operations. For example, the seismic data output may be used to perform geological, geophysical, reservoir engineering, and/or production simulations. The reservoir, wellbore, surface and/or process data may be used to perform reservoir, wellbore, or other production simulations. The data outputs from the field operation may be generated directly from the sensors (S), or after some preprocessing or modeling. These data outputs may act as inputs for further analysis.

The data is obtained and stored at the surface unit (134). One or more surface units (134) may be located at the field (100), or linked remotely thereto. The surface unit (134) may be a single unit, or a complex network of units used to perform the necessary data management functions throughout the field (100). The surface unit (134) may be a manual or automatic system. The surface unit (134) may be operated and/or adjusted by a user.

The surface unit (134) may be provided with a transceiver (137) to allow communications between the surface unit (134) and various portions (or regions) of the field (100) or other locations. The surface unit (134) may also be provided with or functionally linked to a controller for actuating mechanisms at the field (100). The surface unit (134) may then send command signals to the field (100) in response to data received. The surface unit (134) may receive commands via the transceiver or may itself execute commands to the controller. A processor may be provided to analyze the data (locally or remotely) and make the decisions to actuate the controller. In this manner, the field (100) may be adjusted based on the data obtained to optimize fluid recovery rates, or to maximize the longevity of the reservoir and its ultimate production capacity. These adjustments may be made automatically based on computer protocol, or manually by an operator. In some cases, well plans may be adjusted to select optimum operating conditions, or to avoid problems.

FIG. 1.3 depicts a wireline operation being performed by a wireline tool (106.3) suspended by the rig (128) and into the wellbore (136) of FIG. 1.2. The wireline tool (106.3) is adapted for deployment into a wellbore (136) for performing well logs, performing downhole tests and/or obtaining samples. The wireline tool (106.3) may be used to provide another method and apparatus for performing a seismic survey operation. The wireline tool (106.3) of FIG. 1.3 may have an explosive or acoustic energy source (143) that provides electrical signals to the surrounding subterranean formations (102).

The wireline tool (106.3) may be operatively linked to, for example, the geophones (118) stored in the computer (122.1) of the seismic recording truck (106.1) of FIG. 1A. The wireline tool (106.3) may also provide data to the surface unit (134). As shown data output (135) is generated by the wireline tool (106.3) and obtained at the surface. The wireline tool (106.3) may be positioned at various depths in the wellbore (136) to provide a survey of the subterranean formation.

FIG. 1.4 depicts a production operation being performed by a production tool (106.4) deployed from the rig (128) and into the completed wellbore (136) of FIG. 1.3 for drawing fluid from the downhole reservoirs into surface facilities (142). Fluid flows from reservoir (104) through wellbore (136) and to the surface facilities (142) via a surface network (144). Sensors (S) positioned about the field (100) are operatively connected to a surface unit (142) for obtaining data therefrom. During the production process, data output (135) may be obtained from various sensors (S) and passed to the surface unit (134) and/or processing facilities. This data may be, for example, reservoir data, wellbore data, surface data, and/or process data.

While FIGS. 1.1 through 1.4 depict monitoring tools used to measure properties of a field (100), it will be appreciated that the tools may be used in connection with non-wellsite operations, such as mines, aquifers or other subterranean facilities. Also, while certain data acquisition tools are depicted, it will be appreciated that various measurement tools capable of sensing properties, such as seismic two-way travel time, density, resistivity, production rate, etc., of the subterranean formation and/or its geological structures may be used. Various sensors (S) may be located at various positions along the subterranean formation and/or the monitoring tools to obtain and/or monitor the desired data. Other sources of data may also be provided from offsite locations.

The field configuration in FIGS. 1.1 through 1.4 is not intended to limit the scope of integrating field data. Part, or all, of the field (100) may be on land and/or sea. Also, while a single field at a single location is depicted, the present inventive concept may be used with any combination of one or more fields (100), one or more processing facilities and one or more wellsites. Additionally, while one wellsite is shown, it will be appreciated that the field (100) may cover a portion of land that hosts one or more wellsites. One or more gathering facilities may be operatively connected to one or more of the wellsites for obtaining downhole fluids from the wellsite(s).

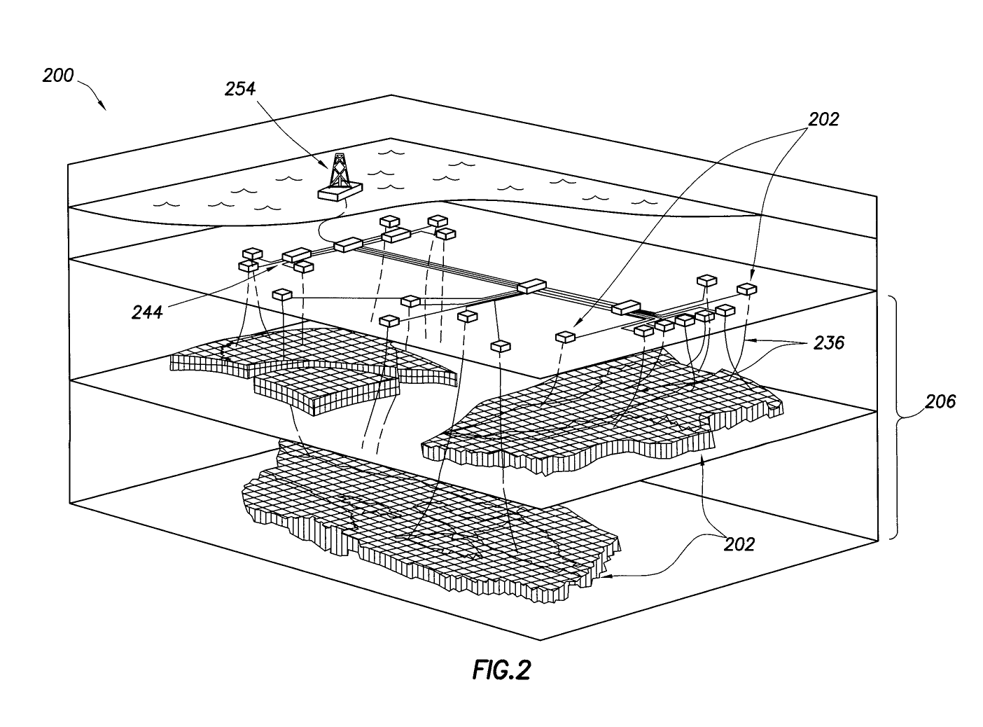

FIG. 2 depicts a field (200) for performing production operations. As shown, the field (200) has a plurality of wellsites (202) operatively connected to a central processing facility (254). The field configuration of FIG. 2 is not intended to limit the scope of integrating field data. Part or all of the field (200) may be on land and/or sea. Also, while a single field with a single processing facility and a plurality of wellsites is depicted, any combination of one or more fields, one or more processing facilities and one or more wellsites may be present.

Each wellsite (202) has equipment that forms a wellbore (236) into the earth. The wellbores extend through subterranean formations (206) including reservoirs (204). These reservoirs (204) contain fluids, such as hydrocarbons. The wellsites (202) draw fluid from the reservoirs (204) and pass them to the processing facilities via surface networks (244). The surface networks (244) have tubing and control mechanisms for controlling the flow of fluids from the wellsite (202) to the processing facility (254).

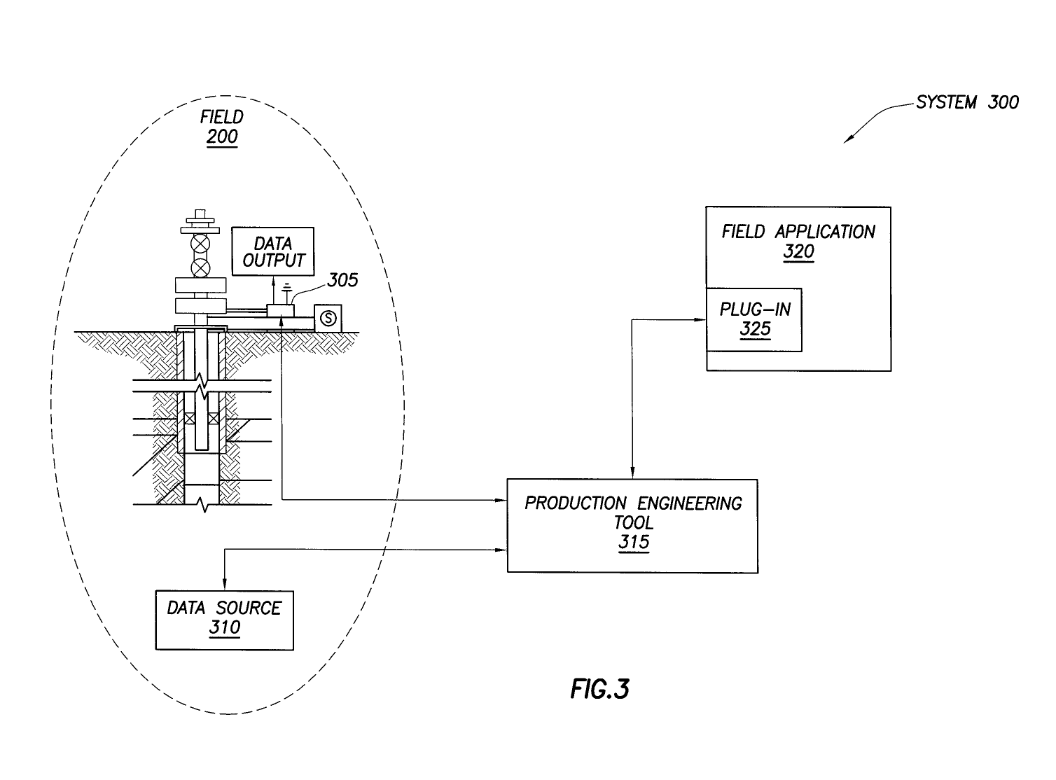

FIG. 3 depicts a system (300) for performing field production operations. As shown in FIG. 3, the system (300) has multiple components, including a surface unit (305), a production engineering tool (315), a field application (320) having a plug-in (325), and a data source (310). The surface unit (305) and/or data source (310) may be optionally within a field (200), such as the field described and shown in FIG. 2. Each of these components are described below and may be located on the same device (e.g., a server, mainframe, desktop Personal Computer (PC), laptop, Personal Digital Assistant (PDA), television, cable box, satellite box, kiosk, telephone, mobile phone, etc.) or may be located on separate devices connected by a network (e.g., the Internet), with wired and/or wireless segments.

The surface unit (305) may be similar to the surface unit discussed above in reference to FIGS. 1.2 through 1.4. In other words, the surface unit (305) is provided with computer facilities for receiving, storing, processing, and analyzing data from the field. The surface unit (305) may obtain field data (e.g., static data, dynamic data, real-time data, historical data) from the field (200), including data measured by one or more sensors (S). The data source (310) may obtain and/or store data from the field (200) in a similar fashion as the data obtained by the surface unit (305). Examples of a data source (310) may be a producing well, components of a gathering network, a variety of seismic data (both static and real-time), etc.

The production engineering tool (315) is configured to receive and store data from the surface unit (305) and/or the data source (310). The received data may be transformed (e.g., filtered, normalized, and/or time-shifted) by the production engineering tool (315) to create data meaningful for engineering use. The received data may also be transformed by the production engineering tool (315) to determine values for variables in the field that are not directly measured.

The production engineering tool (315) is further configured to perform a production analysis on the field data and generate a production output. For example, the production output may be a production forecast for one or more wells in the field based on the received data. The production engineering tool (315) may generate production forecasts by extrapolating production decline curves. Production decline curves depict oil production versus time. As oil wells begin production at a very high rate, decline rapidly, and then level off at a low rate with slow decline, production decline curves are often exponential decline curves. Using received historical data, a partial production decline curve may be plotted and then extrapolated to forecast future production. In addition, the production engineering tool (315) may be configured to compare and display multiple production forecasts from a variety of sources (e.g., an earth model simulation application, a drilling application, a field economics application, a geophysics application, a production engineering application, an optimization application, a well analysis application, a geoscience application, etc.).

Continuing with FIG. 3, the system (300) also includes a field application (320) operatively connected to the production engineering tool (315). The field application (320) is configured to obtain data from the production engineering tool (315). For example, the field application (320) may obtain production and injection flow rates, production and injection pressures, well hardware, and/or completion information from the production engineering tool (315). The field application (320) may be an earth model simulation application, a drilling application, a field economics application, a geophysics application, a production engineering application, an optimization application, a well analysis application, and/or a geoscience application.

The field application (320) is further configured to perform a field analysis of field data and generate a field output. For example, the field output may be a production forecast for one or more wells in the field based on the information received from the production engineering tool (315). The generated production forecast may be returned to the production engineering tool (315) for further analysis.

The field application (320) may be an open component that permits the addition of a plug-in (325) to add external functionality to the component. For example, the plug-in (325) allows the field application (320) to interface with and control the production engineering tool (315). The plug-in (325) may include a graphical user interface (GUI) for use in extracting data from the production engineering tool (315) (i.e., using one or more request messages) and populate the one or more data elements of the field application (320). Such plug-ins (325) may be added using existing products, such as OCEAN™ (Ocean is a registered trademark of Schlumberger Technology Corporation, located in Houston, Tex.).

As an alternative to the plug-in (325), the field application (320) may import files generated by the production engineering tool (315). Similarly, the production engineering tool (315) may import files generated by the field application (320) as an alternative to receiving messages from the production engineering tool (315) (discussed below).

The system (300) may include additional external applications (not shown) operatively connected to the production engineering tool (315) using one or more plug-ins that are substantially the same as the plug-in (325) shown and described in association with FIG. 3.

While specific components are depicted and/or described for use in the units and/or modules of the system (300), it will be appreciated that a variety of components with various functions may be used to provide the formatting, processing, utility and coordination functions necessary to provide field data integration in the system (300). The components may have combined functionalities and may be implemented as software, hardware, firmware, or combinations thereof.

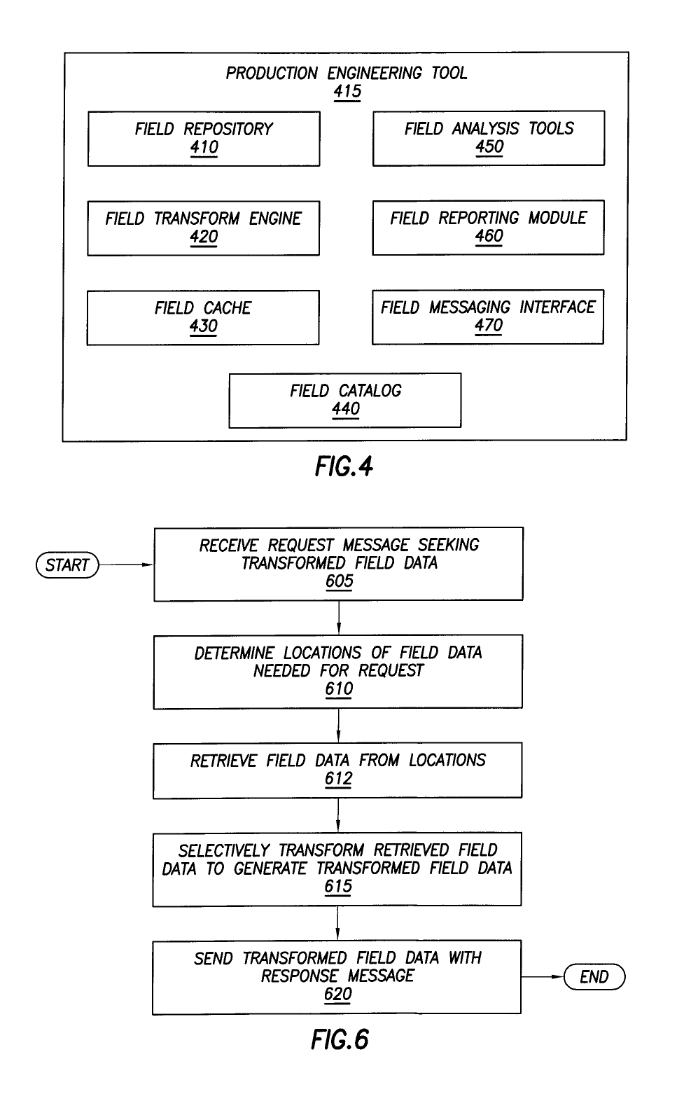

FIG. 4 illustrates a production engineering tool of the system shown in FIG. 3 in which one or more embodiments of integrating field data may be implemented. The production engineering tool (415) may be substantially similar to the production engineering tool discussed above in reference to FIG. 3. Further, the production engineering tool (415) may be an Oil Field Data Management (OFM) system.

As shown in FIG. 4, the production engineering tool (415) has multiple components including a field repository (410), a field transformation engine (420), a field cache (430), a field catalog (440), one or more field analysis tools (450), a field reporting module (460), and a field messaging interface (470). Each of these components may be physically or logically located within the production engineering tool (415) or may be a component physically or logically removed from the production engineering tool (415), but supporting the production engineering tool (415) remotely. Each of these components is described below.

The field repository (410) stores data received by and/or transformed by the production engineering tool (415). The field repository (410) may be a relational database, a hierarchical database, a flat file, a database management system, or any type of data store. Access to contents of the repository may be achieved using one or more data requests/queries. These requests/queries may be generated using a simple user interface or complex programming language interface.

The field transformation engine (420) is configured to perform calculations on field data received by the production engineering tool (415). In other words, the field transformation engine (420) is configured to transform (e.g., time-shift, normalize, and/or filter) the received data using any known algorithm(s). The field transformation engine (420) may also store the mathematical formulas used for said calculations.

A time-shifting transformation may typically involve the alignment of historical oil and gas production trends in order to evaluate the trends relative to a specific event in the life of each well. For example, many wells in a producing field may have been drilled and produced over different calendar time periods; however, each of these wells may have been treated with a hydraulic fracture during some point in the well's life. By time-shifting the historical production of each well relative to the hydraulic fracture date, the field transformation engine (420) may align the production trend of each well so the trends may be evaluated relative to the same event (i.e., the hydraulic fracture).

A normalization transformation may typically involve applying factors to historical oil and gas production trends in order to evaluate the trends relative to a well-specific factor. For example, many wells in a producing field may be produced at different rates; however, the relative performance of each well may not be dependent on the absolute values of these rates, but on the rate values normalized to a parameter that is indicative of the quality of the reservoir in the vicinity of the well. By dividing the historical production trend of each well by the value of that well's reservoir quality parameter, the performance of each well may be more valuably compared.

A filtering function transformation may typically involve the screening of some values from historical oil and gas production trends so that the remaining values are more meaningful for analysis. For example, production spikes or obviously incorrect production values may be removed from the production trend so that the trend may be more accurately projected into the future.

The field cache (430) stores a subset of the data found in the field repository (410). The field cache (430) is populated by the field transformation engine (420) using a series of data requests sent to the field repository (410).

The field cache (430) serves as an intermediate storage mechanism for database data that is used during the performance of a field operation. The database may contain much more data than is needed for, or much more data that may be efficiently used by, a single instance of the production engineering tool (415). The field cache (430) retrieves the data, and saves it for efficient retrieval during the performance of a field operation.

The field catalog (440) stores a list of wells in the field (200 in FIGS. 2 and 3). The field catalog (440) also stores lookup information from which data elements in the repository (410) may be located. The field catalog (440) may be populated based on the field cache (430).

The field analysis tools (450) (e.g., a map analysis tool, a pattern analysis tool, etc.) are used to perform one or more types of analysis (e.g., pattern analysis, well log analysis, map analysis, material balance analysis, and allocation analysis) on the received data. Accordingly, the field analysis tools (450) are operatively connected to the field repository (410) storing the received data and accessible by a user of the production engineering tool (415) with interest in the received data. For example, the field analysis tools (450) may generate a production forecast (e.g., a production decline curve) of one or more wells in the field. The field analysis tools (450) may also be configured to compare multiple production forecasts received from any source.

A map analysis tool of the field analysis tools (450) may apply transformed data to one or more maps so that the aerial distribution of the transformed data may be evaluated and analyzed. For example, reservoir pressure calculated for each well may be applied to a location on a map that corresponds to the actual location of each well. The pressure values may then be contoured so that reservoir pressure values may be estimated at intermediate locations.

A pattern analysis tool of the field analysis tools (450) may aggregate transformed data based on sections of the reservoir defined by no-flow boundaries (i.e., patterns). By evaluating production and injection trends within these patterns, it is possible to make decisions that may optimize the overall production from within the pattern. The evaluations may be done via graphical presentations of the aggregated transformed data, or by computing results that indicate the efficiency of the pattern.

The field reporting module (460) is used to display (e.g., on a monitor or other display device) data received by and/or transformed by the production engineering tool (415) for an end user. The field reporting module (460) is also configured to generate reports following analysis of the received data. The reports may be generated based on criteria provided by the user.

The field messaging interface (470) permits control and automation of the production engineering tool (415) by one or more external applications (e.g., earth model simulation application, a drilling application, a field economics application, a geophysics application, a production engineering application, an optimization application, a well analysis application, a geoscience application, etc.). The messaging interface (470) is configured to translate received messages into internal actions that initialize the production engineering tool (415), populate the field catalog (440) and the field cache (430), dispatch requests to the field repository (410) for data, and return the results (i.e., transformed field data) along with a corresponding message back through the field messaging interface (470).

The production engineering tool (415) may also include modules (not shown) for alarm handling, data security, user management, among others.

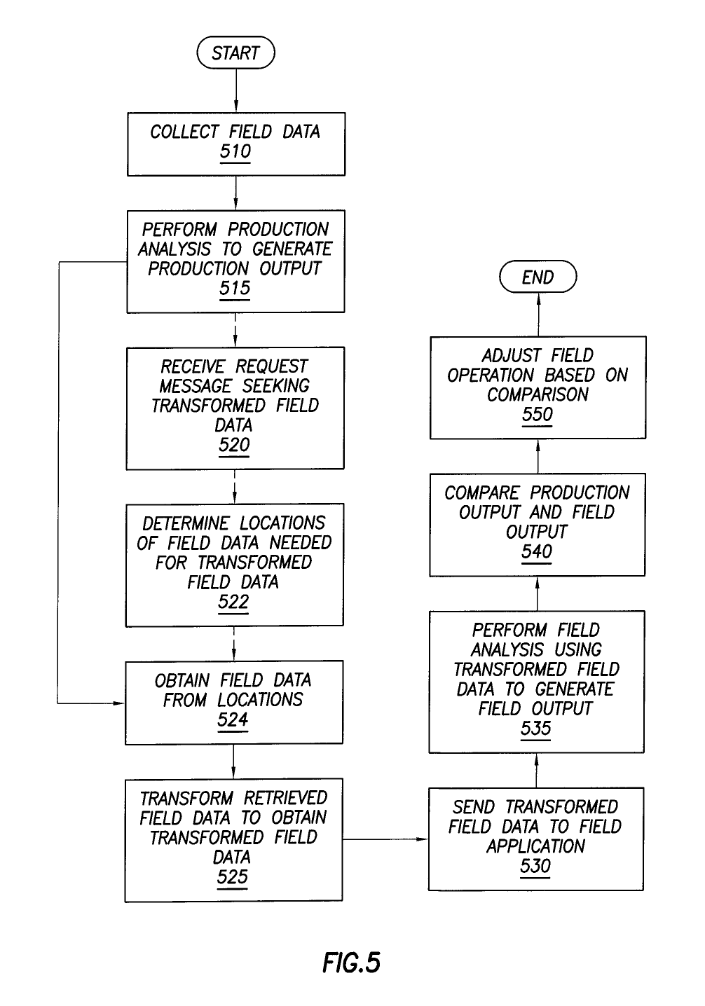

FIG. 5 depicts a flowchart illustrating a method for integrating field data in accordance with one or more embodiments. One or more of the blocks shown in FIG. 5 may be omitted, repeated, and/or performed in a different order than that shown in FIG. 5. In addition, a person of ordinary skill in the art will appreciate that other blocks, omitted in FIG. 5, may be included in one or more of these flowcharts. Accordingly, the specific arrangement of blocks shown in FIG. 5 should not be construed as limiting the scope of integrating field data.

Initially, field data is collected (BLOCK 510). The collected field data may be obtained from and transmitted by a surface unit (i.e., the surface unit as discussed above in reference to FIG. 3), and the collected field data may include historical data, real-time data, static data, dynamic data, and any combinations thereof.

In BLOCK 515, a production analysis is performed using the obtained field data to generate a production output. The production output may be a production forecast for at least one well in the field. In some cases, generating the production forecast may include constructing a partial production decline curve for a well in the field using the collected field data (i.e., BLOCK 510), and then extrapolating the production decline curve (i.e., using linear extrapolation, polynomial extrapolation, conic extrapolation, etc.) to generate the production forecast. The process then proceeds to BLOCK 524.

Optionally, in BLOCK 520, a request message is received seeking transformed field data. The request message may be, for example, a request initialization message, a request filter message, a trajectory request message, a return well equipment message, a return event message, a return production volume message, and/or a return injection volume message. In essence, the message relates to a request associated with information about one or more portions of the field. The request message may originate from a plug-in of a field application (e.g., the field application as discussed above in reference to FIG. 3) or from any source in a field capable of originating such a message.

Optionally, in BLOCK 522, the locations of the field data that are used to generate the transformed field data are determined. Determining the location of the data element(s) may include consulting a field catalog in the production engineering tool having tables and/or other data structures necessary to lookup the location(s). In BLOCK 524, the field data is obtained from the determined locations.

In BLOCK 525, the retrieved field data is transformed (i.e., using one or more calculations) to generate the transformed field data sought by the request message. In other words, one or more calculations may be applied to the received data elements to produce said transformed field data. The transformations may include, for example, converting the received data elements from incremental changes in location versus depth into underground position versus depth. The transformations may also include, for example, converting the received data elements to a unit system appropriate for the source of the request message (e.g., a plug-in (325 of FIG. 3) or a field application (320 of FIG. 3)).

In BLOCK 530, the transformed field data is sent to the field application. In one or more embodiments, the transformed field data may be combined with a response message prior to sending the transformed field data. The transformed field data may be sent to the source of the request message (e.g., a plug-in (325 of FIG. 3) or a field application (320 of FIG. 3)). A plug-in may also be used as a mapping interface to translate the transformed field data and/or the response message into a data format compatible by the field application.

In BLOCK 535, a field analysis is performed using the transformed field data to generate a field output. For example, the field output may be a production forecast for at least one well in the field. The production forecast may be generated by the field application (or by any tool capable of generating such a forecast) using the sent transformed field data (BLOCK 530). The production forecast could also be imported from data exported by the field application tool.

In BLOCK 540, the production output and the field output are compared. This comparison may be outputted in any format (e.g., chart, graphs, etc.) accessible by a user or a person with interest in the field output and/or the production output.

In BLOCK 550, a field operation is adjusted based on the comparison of the production output and the field output. The adjustment may be executed to improve (e.g., increase) the extraction of oil, gas, and/or water from one or more wells in the field.

As discussed above, the blocks in FIG. 5 may be used to generate and compare well production forecasts. However, the blocks in FIG. 5 may be used to generate and compare analysis (i.e., an analysis performed by a production engineering tool and a separate analysis performed by the earth model simulation tool) of any type. Since the production engineering tool and the field application each performs analysis based on a different set of constraints, it is valuable to be able to compare the results to confirm the accuracy of each analysis.

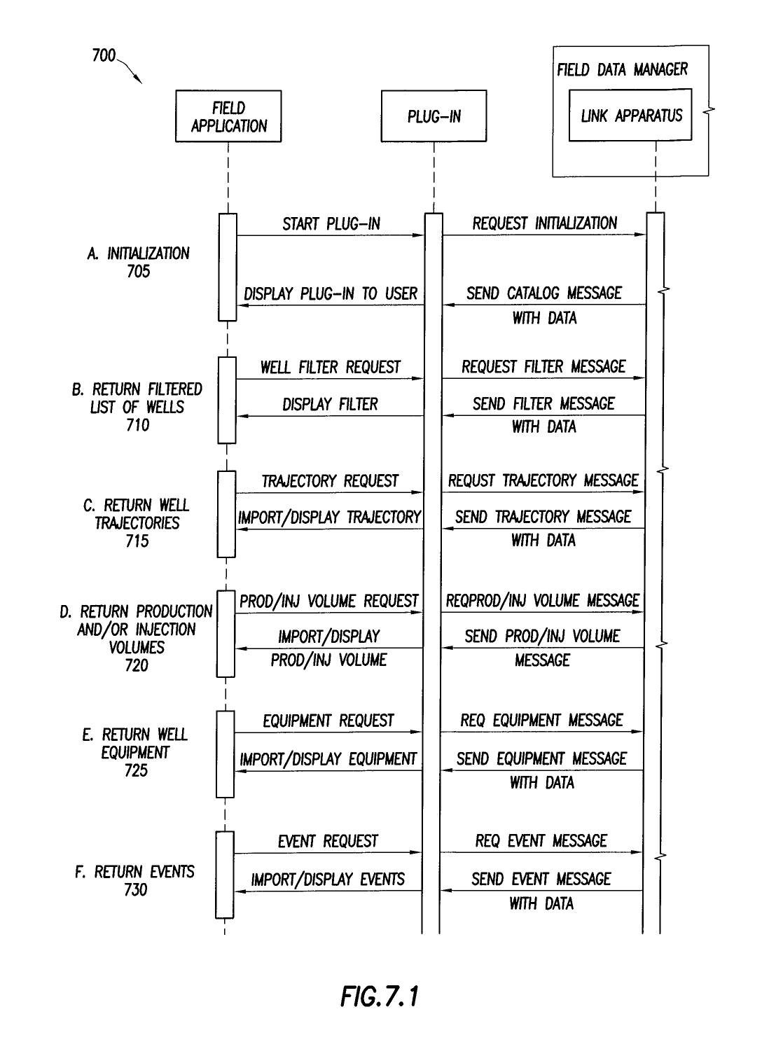

FIG. 6 depicts a flowchart illustrating a method for integrating field data in accordance with one or more embodiments. One or more of the blocks shown in FIG. 6 may be omitted, repeated, and/or performed in a different order than that shown in FIG. 6. In addition, a person of ordinary skill in the art will appreciate that other blocks, omitted in FIG. 6, may be included in one or more of these flowcharts. Accordingly, the specific arrangement of blocks shown in FIG. 6 should not be construed as limiting the scope.

Initially, in BLOCK 605, a request message is received seeking transformed field data based on obtained field data elements stored in the production engineering tool. The source of the request message may be a plug-in of a field application (e.g., the plug-in as discussed above in reference to FIG. 3) or from any source in a field capable of originating such a message. The request message may be received by a messaging interface of the production engineering tool (e.g., the field messaging interface as discussed above in reference to FIG. 4). The request message may be, for example, a request initialization message, a request filter message, a trajectory request message, a return well equipment message, a return event message, a return production volume message, and/or a return injection volume message.

In BLOCK 610, the locations of the field data that are used to answer the request are determined. Determining the location of the field data may include consulting a field catalog in the production engineering tool having tables and/or other data structures necessary to look-up the location(s). In BLOCK 612, the field data is retrieved from the determined locations.

In BLOCK 615, the field data is transformed to generate the transformed field data sought by the request message. Transforming the data elements may include the application of one or more calculations to the data elements by a field transformation engine (i.e., the field transformation engine as discussed above in reference to FIG. 4). The mathematical formulas for performing the calculations may also be stored in the field transformation engine.

In BLOCK 620, the transformed field data sought by the request message is combined with a response message (i.e., generated by a field messaging interface) and sent in response to the request message. In other words, the transformed field data is sent back to the plug-in of the field application (or other application capable of receiving such transformed field data), and used to populate the data elements of the field.

The blocks shown in FIG. 6 may be preceded by receiving a request initialization message which starts the field transformation engine and populates the field catalog with a list of wells in the field and the lookup information by which subsequent request for transformed field data (e.g., BLOCK 605) may be located and resolved.

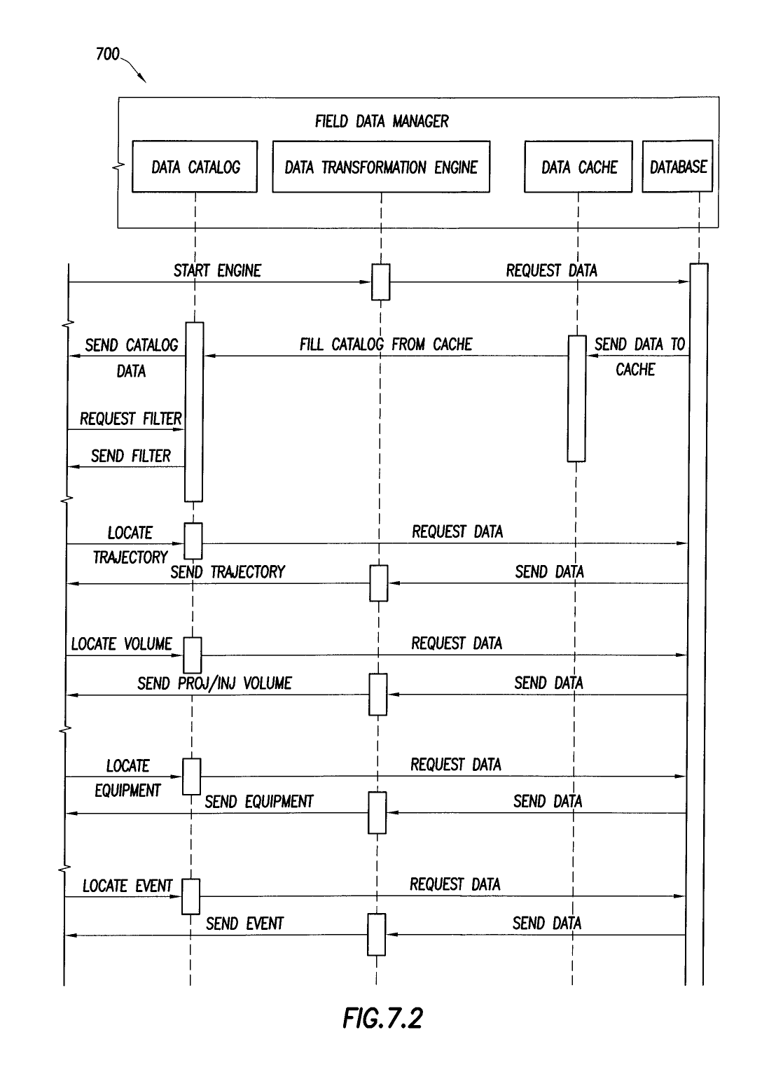

FIGS. 7.1 to 7.2 illustrate various examples being performed by a system in which one or more embodiments of integrating field data may be implemented. More specifically, FIGS. 7.1 to 7.2 depict a use of the plug-in, an OFM system (i.e., the engineering production tool) with a link apparatus (e.g., field messaging interface), a data catalog (i.e., a field catalog), a data transformation engine (i.e., field transformation engine), a data cache (i.e., field cache), a database (i.e., field repository), and an external application through a sequence diagram (700). While the following example is specific to an implementation involving the OFM system and a plug-in to an earth model simulation tool, this example should not be deemed as limiting integrating field data to this particular example. With respect to the OFM, the sequence of events in FIGS. 7.1 to 7.2, as experienced by the OFM, are described specifically below.

Initialization (705)

Upon receipt of a “Request Initialization” message, the OFM system initiates the Data Transformation Engine and populates the Data Cache by a sequence of requests for data from the repository. The Data Catalog is then populated from the Data Cache. The Data Catalog contains the list of wells in the OFM system workspace, as well as the lookup information by which subsequent requests for transformed field data may be located and resolved. A subset of the Data Catalog information (well categories, and unit system information) is returned to the plug-in via a Message with Data.

Return Filtered List of Wells (710)

Upon receipt of a “Request Filter” message, the OFM system extracts the appropriate filter from the Data Catalog and returns the filter to the plug-in via a Message with Data. The OFM system determines the contents of the filter by the type of “Request Filter” message. For example, the “Request Filter” message may request a list of wells that are currently producing within a specific common reservoir. In such an example, the OFM system would determine which wells currently produced within the specified reservoir and respond by supplying the resulting list of wells.

Return Well Trajectories (715)

Upon receipt of a “Trajectory Request” message, the OFM system determines the repository location of the trajectory information from the Data Catalog, prepares a request for the appropriate data from the repository, transforms the returned repository data into appropriate trajectory values, and returns the trajectory values via the messaging interface to the plug-in via a Message with Data. The transformations that may occur on the database data include: (i) converting database data (incremental changes in location versus depth) into underground position versus depth; and (ii) converting the underground position to a unit system appropriate for the plug-in.

Return Production and/or Injection Volumes (720)

Upon receipt of a “Prod/Inj Volume” message, the OFM system first consults the Data Catalog for the mathematical formula necessary to calculate the volume, and the repository location of the various components of the requested volume. The OFM system then issues a request to the repository for the component data, computes the appropriate volume result in the Data Transformation Engine, and returns the computed volume via the messaging interface to the plug-in via a Message with Data. Note that although a possible use of this interface is for Production and Injection Volumes (oil, water, gas produced, water, gas injected), the interface may also be used for obtaining other information such as pressure or temperature history, ratios of injected or produced fluids, or fractional components of produced or injected fluids. The method of computing the result follows the same general method.

Return Well Equipment (725)

Upon receipt of an “Equipment Request” message, the messaging interface uses built-in logic to determine the subset of possible equipment that may effectively be used by the plug-in. The OFM system then consults the Data Catalog for the repository location of the various components of the requested well equipment. The OFM system then issues a request to the repository for the equipment data, transforms the returned repository data into appropriate equipment values, and returns the equipment values via the messaging interface to the plug-in via a Message with Data. The transformations that may occur on the database data include: (i) associating database equipment data with the appropriate casing or tubing string identified by the plug-in; and (ii) converting the subsurface depth to a unit system appropriate for the plug-in

Return Events (730)

Upon receipt of an “Event Request” message, the OFM system first consults the Data Catalog for the mathematical formulas necessary to calculate the event, and the repository location of the various components of the requested event. The OFM system then issues a request to the repository for the component parts of the event, computes the appropriate event result in the Data Transformation Engine, and returns the computed event via the messaging interface to the plug-in via a Message with Data. Note that although a possible use of this interface is for events associated with changes in the reservoir near the well (damage, stimulation, productivity, or injectivity), the interface is also used for obtaining other information such as pressure or temperature history, ratios of injected or produced fluids, or fractional components of produced or injected fluids. The method of computing the result follows the same general method.

With respect to the plug-in, the sequence of events in FIGS. 7.1 to 7.2, as experienced by the plug-in, are described specifically below.

Initialization (705)

A user, through the Application (i.e., earth model simulation tool), starts the plug-in by a method such as selecting an “Import File” option, and then selecting “OFM wells and well paths” which appears as a drop-down item in the Application. The plug-in then invokes a “Request Initialization” message on the OFM system and waits to receive the subset of the Data Catalog information (well categories and unit system information) via a Message with Data from the OFM system. The plug-in then displays this catalog information to the user via a dialog in the Application.

Return Filtered List of Wells (710)

A user, through the plug-in Dialog presented in the Application, requests a filtered list of wells from the OFM system. The plug-in then invokes a “Request Filter” message on the OFM system and waits to receive the appropriate filter via a Message with Data from the OFM system.

Return Well Trajectories (715)

A user, through the plug-in Dialog presented in the Application, requests well trajectories from the OFM system. The plug-in then invokes a “Trajectory Request” message on the OFM system, and waits to receive the trajectories via a Message with Data from the OFM system. Using the built-in Application API, the plug-in then populates the appropriate data members in the Application from the trajectory results received from the OFM system.

Return Production and/or Injection Volumes (720)

A user, through the plug-in Dialog presented in the Application, requests production and/or injection volumes from the OFM system. The plug-in then invokes a “Prod/Inj Volume” message on the OFM system then waits for the computed volumes to be received via a Message with Data from the OFM system. The plug-in then populates the corresponding data members in the Application from the volume results received from the OFM system. Note that although the primary use of this interface is for Production and Injection Volumes (e.g., oil, water, gas produced, water, gas injected), the interface is also used for obtaining other information such as pressure or temperature history, ratios of injected or produced fluids, or fractional components of produced or injected fluids. The method of obtaining the result follows the same general method.

Return Well Equipment (725)

A user, through the plug-in Dialog presented in the Application, requests equipment information from the OFM system. The plug-in then invokes an “Equipment Request” message, and waits for the equipment information to be received via a Message with Data from the OFM system. The plug-in then populates the corresponding data members in the Application from the equipment results received from the OFM system.

Return Events (730)

A user, through the plug-in Dialog presented in the Application, requests event information from the OFM system. The plug-in then invokes an “Event Request” message on the OFM system, and waits for the equipment information to be received via a Message with Data from the OFM system. The plug-in then populates the corresponding data members in the Application from the equipment results received from the OFM system. Note that although the primary use of this interface is for events associated with changes in the reservoir near the well (e.g., damage, stimulation, productivity, or injectivity), the interface is also used for obtaining other information such as pressure or temperature history, ratios of injected or produced fluids, or fractional components of produced or injected fluids. The method of obtaining the result follows the same general method.

Although the details of this disclosure describe the integration aspects, apparatus and method for integration between a production engineering tool and an earth model simulation tool, the scope is equally applicable to other types of Applications, including but not limited to Drilling, Geophysical, Well Log Analysis, Optimization, Production, Economics, and Geoscience Applications.

The systems and methods provided relate to acquisition of fluids (including, but not limited to, hydrocarbons) from a field. It will be appreciated that the same systems and methods may be used for performing subsurface operations, such as mining, water retrieval, and acquisition of other underground materials.

While specific configurations of systems for performing field operations are depicted, it will be appreciated that various combinations of the described systems may be provided. For example, various combinations of selected modules may be connected using the connections previously described. One or more modeling systems may be combined across one or more fields to provide tailored configurations for modeling a given field or portions thereof. Such combinations of modeling may be connected for interaction therebetween. Throughout the process, it may be desirable to consider other factors, such as economic viability, uncertainty, risk analysis and other factors. It is, therefore, possible to impose constraints on the process. Modules may be selected and/or models generated according to such factors. The process may be connected to other model, simulation and/or database operations to provide alternative inputs.

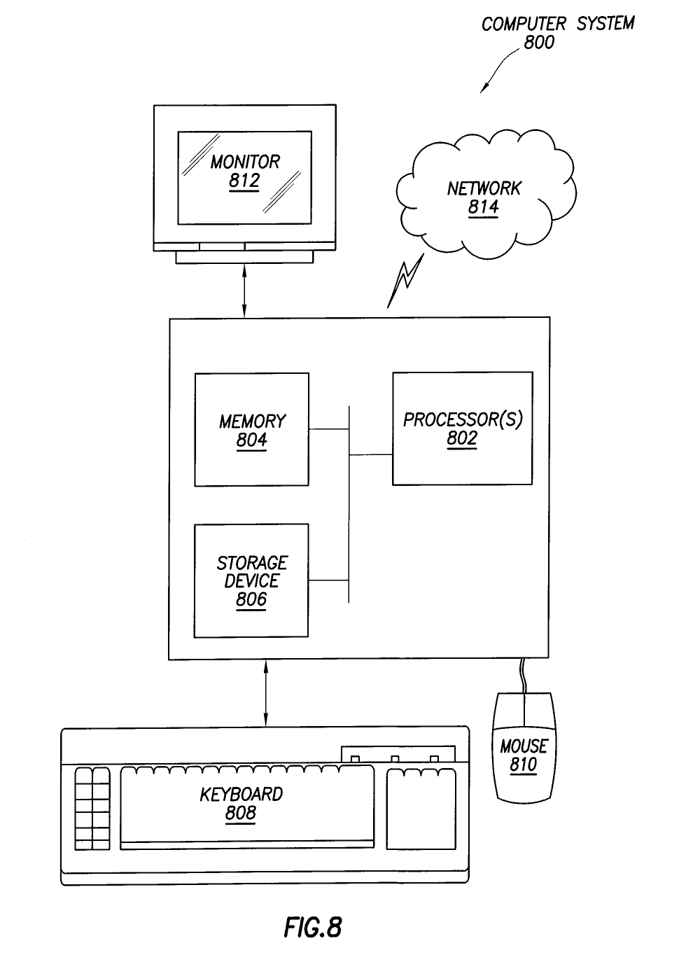

Embodiments of integrating field data may be implemented on virtually any type of computer regardless of the platform being used. For instance, as shown in FIG. 8, a computer system 800 includes one or more processor(s) 802, associated memory 804 (e.g., random access memory (RAM), cache memory, flash memory, etc.), a storage device 806 (e.g., a hard disk, an optical drive such as a compact disk drive or digital video disk (DVD) drive, a flash memory stick, etc.), and numerous other elements and functionalities typical of today's computers (not shown). The computer 800 may also include input means, such as a keyboard 808, a mouse 810, or a microphone (not shown). Further, the computer 800 may include output means, such as a monitor 812 (e.g., a liquid crystal display LCD, a plasma display, or cathode ray tube (CRT) monitor). The computer system 800 may be connected to a network 814 (e.g., a local area network (LAN), a wide area network (WAN) such as the Internet, or any other similar type of network) via a network interface connection (not shown). Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means may take other forms. Generally speaking, the computer system 800 includes at least the minimal processing, input, and/or output means necessary to practice one or more embodiments.

Further, those skilled in the art will appreciate that one or more elements of the aforementioned computer system 800 may be located at a remote location and connected to the other elements over a network. Further, one or more embodiments may be implemented on a distributed system having a plurality of nodes, where each portion of the implementation (e.g., the field application, the integration module) may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform one or more embodiments may be stored on a computer readable medium such as a compact disc (CD), a diskette, a tape, or any other computer readable storage device.

It will be understood from the foregoing description that various modifications and changes may be made in the embodiments of integrating field data without departing from its true spirit. For example, during a real-time drilling of a well it may be desirable to update the field model dynamically to reflect new data, such as measured surface penetration depths and lithological information from the real-time well logging measurements. The field model may be updated in real-time to predict the location in front of the drilling bit. Observed differences between predictions provided by the original field model concerning well penetration points for the formation layers may be incorporated into the predictive model to reduce the chance of model predictability inaccuracies in the next portion of the drilling process. In some cases, it may be desirable to provide faster model iteration updates to provide faster updates to the model and reduce the chance of encountering an expensive field hazard. In another example, it may be desirable for the production engineering tool (e.g., OFM system) to dynamically update the earth model simulation tool via the plug-in in response to a new event such as a new producing well or new data available in the database.

While integrating field data has been described with respect to a limited number of embodiments, those skilled in the art, having benefit of this disclosure, will appreciate that other embodiments may be devised which do not depart from the scope as disclosed herein. Accordingly, the scope should be limited only by the attached claims.

What is claimed is:

1. A method of integrating field data, comprising:
obtaining the field data associated with a field;
performing a production analysis on the field data to generate a production output, the production analysis performed by a production engineering tool;
transforming the field data to obtain transformed field data requested by a field application;
sending the transformed field data from the production engineering tool to the field application, the field application performing a field analysis using the transformed field data to generate a field output; and
generating a comparison of the production output and the field output.

2. The method of claim 1, wherein obtaining the field data associated with the field further comprises:
receiving a request message associated with the field data from the field application;
in response to the request message, using a field catalog to determine a location of the field data in a field repository; and
obtaining the field data from the location.

3. The method of claim 1, wherein the field application is an earth model simulator.

4. The method of claim 1, wherein the comparison is used to adjust a field operation.

5. The method of claim 1, wherein the field data is a location versus a depth and the transformed field data is an underground position versus the depth.

6. The method of claim 1, wherein each of the production output and the field output are decline curves.

7. A system for integrating field data, comprising:
a field application configured to perform a field analysis on the field data to generate a field output;
a production engineering tool communicatively coupled to the field application and configured to:
obtain the field data and perform a production analysis on the field data to generate a production output, and
generate a comparison of the production output and the field output; and
a plug-in configured to receive the field data from the production engineering tool for the field application.

8. The system of claim 7, wherein the production engineering tool comprises:
a field repository storing the field data;
a field transformation engine configured to selectively perform one or more calculations using the field data;
a field catalog comprising a list of wells in a field and lookup information for locating the field data in the field repository;
a field forecasting tool configured to forecast production of the field based on the field data; and
a field messaging interface configured to translate a request message and initiate a response to the request message, the response being generated by the field catalog, the field transformation engine, and the field repository.

9. The system of claim 8, wherein the production engineering tool is further configured to send a response message with the field data in response to the request message.

10. The system of claim 8, wherein the production engineering tool further comprises a field cache operatively connected to the field transformation engine and configured to populate the field catalog using the field data received from the field repository.

11. The system of claim 7, wherein the field data comprises production history of a well in the field and the production output is a decline curve of the well.

12. The system of claim 7, wherein the field data is associated with well tubing.

13. The system of claim 7, wherein the field application is an earth model simulator.

14. A computer readable medium storing instructions for integrating field data, the instructions comprising functionality to:
receive a request message associated with the field data from a field application;
in response to the request message, use a field catalog to determine a location of the field data in a field repository;
obtain the field data from the location;
perform a production analysis on the field data to generate a production output, the production analysis performed by a production engineering tool;
transform the field data to obtain transformed field data requested by the field application;
send the transformed field data from the production engineering tool to the field application, the field application performing a field analysis using the transformed field data to generate a field output; and
generate a comparison of the production output and the field output.

15. The computer readable medium of claim 14, the instructions further comprising functionality to:
receive a request initialization message from a plug-in,
populate a field cache using a plurality of requests for field data from the field repository,
populate the field catalog based on the field cache, the field catalog including a list of wells in a field, and
respond to the request initialization message by sending data from the field catalog to the plug-in prior to receiving the request message.

16. The computer readable medium of claim 14, wherein the comparison is used to adjust a field operation for the field.

17. The computer readable medium of claim 14, wherein the field application is an earth model simulator.

18. The computer readable medium of claim 14, wherein the request message corresponds to requesting a trajectory, and wherein the instruction comprising functionality to transform the field data comprises translating a location versus a depth to an underground position versus the depth.

19. The computer readable medium of claim 14, wherein the instruction comprising functionality to transform the field data comprises transforming a volume using a mathematical formula in the production engineering tool, wherein the request message corresponds to requesting a volume.

20. The computer readable medium of claim 14, wherein the request message corresponds to requesting equipment, and wherein the instruction comprising functionality to transform the field data comprises associating the data item with a casing string.
